(19) United States
(12) Patent Application Publication
(10) Pub. No.: US 2020/0153090 A1
(43) Pub. Date: May 14, 2020

(54) Increasing Light Matter Interactions in Plasmonic Patch Antennae

(71) Applicant: Government of the United States, as represented by the Secretary of the Air Force, Wright-Patterson AFB, OH (US)

(72) Inventor: Joshua R. Hendrickson, Dayton, OH (US)

(21) Appl. No.: 16/683,572

(22) Filed: Nov. 14, 2019

Related U.S. Application Data
(60) Provisional application No. 62/760,948, filed on Nov. 14, 2018.

(51) Int. Cl. H01Q 1/38; H01Q 1/48

(52) U.S. Cl. CPC H01Q 1/38; H01Q 9/16; H01Q 1/48

(57) ABSTRACT

A plasmonic patch antenna is provided that includes an arbitrary substrate with an optically thick ground plane proximate to the substrate. A first dielectric material with a first refractive index is proximate to the ground plane. A second dielectric material with a second refractive index is proximate to the first dielectric material. A periodic array of conducting rectangles is proximate to the second dielectric material. The first refractive index is greater than the second refractive index and a thickness of the first dielectric material is greater than a thickness of the second dielectric material.

### CROSS-REFERENCE TO RELATED APPLICATIONS

This application claims the benefit of and priority to U.S. Provisional Application Ser. No. 62/760,948, entitled “Increasing Light Matter Interactions in Plasmonic Patch Antennaes,” filed on Nov. 14, 2018, the entirety of which is incorporated by reference herein.

### RIGHTS OF THE GOVERNMENT

The invention described herein may be manufactured and used by or for the Government of the United States for all governmental purposes without the payment of any royalty.

### BACKGROUND OF THE INVENTION

### Field of the Invention

The present invention generally relates to patch antennas and, more particularly, plasmonic patch antennas.

### Description of the Related Art

While plasmonic systems can suffer from large ohmic losses they also offer the potential for deep subwavelength light confinement that can be exploited for strong light matter interactions. Photodetectors, pyroelectric detectors, solar cells, and chem/bio-sensors are just a few applications that have benefited from plasmonic enhancement. One specific type of plasmonic based nanocavity system that has been studied is a metal-insulator-metal based patch antenna, which is composed of an optically thick metallic ground plane, a dielectric spacer layer, and a top array of metallic particles. In place of the particle array, an array of apertures etched into a metallic film can also be used, which can subsequently serve as a top electrode for electrical devices. When incident light is on resonance with the gap plasmon mode of a plasmonic patch antenna, perfect absorption can occur. By multiplexing different sizes of particles into the particle array, wideband and multispectral absorption can be obtained.

The modal field distribution in a patch antenna extends throughout the dielectric spacer region, although the field strength is somewhat stronger near the top of the spacer region and at the outer edges of the interface with the top particle/aperture array. At mid infrared wavelengths the spacer layer region thickness needed for perfect light absorption can easily be on the order of several hundred nm. However, in order to increase plasmonic enhancement effects, the spacer layer region needs to be as thin as possible, thereby confining the gap plasmon mode to a smaller volume, all while still maintaining a strong resonance. Accordingly, there is a need in the art for a plasmonic patch antenna with these thinner spacer layer regions.

### SUMMARY OF THE INVENTION

A metal-insulator-metal based plasmonic patch antennae where the insulating spacer layer is composed of both a thicker higher index layer and a thinner low index layer is proposed. The electromagnetic field is shown to be strongly confined to the thinner low index region, thereby increasing the plasmonic field enhancement and light matter interaction strength. Confinement to regions with thicknesses of several atomic layers, and even down to a single monolayer, is possible. At mid-infrared wavelengths the low index layer thickness can be on the order of λ/20,000 with an electric field magnitude enhancement value of 286 times which is predominately oriented in the out-of-plane direction. For an optimally located dipole a radiative enhancement rate of 3.65×10⁵ with 75% quantum efficiency is seen. Furthermore, as the low index layer thickness is reduced the radiative enhancement for an out-of-plane dipole increases exponentially unlike in-plane where a linear increase is observed. Such a hybrid device is attractive for plasmonic coupling and enhancement of deep subwavelength nanofilms and 2D materials which can contain out-of-plane dipole modes and emitters.

Embodiments of the invention provide a plasmonic patch antenna that includes an arbitrary substrate with an optically thick ground plane proximate to the substrate. A first dielectric material with a first refractive index is proximate to the ground plane. A second dielectric material with a second refractive index is proximate to the first dielectric material. A periodic array of conducting rectangles is proximate to the second dielectric material. The first refractive index is greater than the second refractive index and a thickness of the first dielectric material is greater than a thickness of the second dielectric material.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate embodiments of the invention and, together with a general description of the invention given above, and the detailed description given below, serve to explain the invention.

FIG. 1A is a top view of an exemplary plasmonic patch antenna;

FIG. 1B is a side view of the exemplary plasmonic patch antenna of FIG. 1A;

FIG. 2 is a graph of reflectivity spectra for devices, such as those in FIGS. 1A and 1B, with various indices of refraction for the lower index spacer layer;

FIG. 3A is an electric field magnitude profile for a 10 nm thick lower index spacer layer for a refractive index of 1.5 corresponding to the devices of FIG. 2;

FIG. 3B is an electric field magnitude profile for a 10 nm thick lower index spacer layer for a refractive index of 2.5 corresponding to the devices of FIG. 2;

FIG. 3C is an electric field magnitude profile for a 10 nm thick lower index spacer layer for a refractive index of 4.0 corresponding to the devices of FIG. 2;

FIG. 4 is a graph of maximum amplitude of the electric field magnitude for the same devices in FIG. 2 with T1=10 nm−inset shows Q/V values;

FIG. 5 contains a table of metrics where resonant wavelength and absorption are held nominally constant by adjusting higher index layer thickness and gold rectangle length and with lower index spacer layer held constant at a thickness of 10 nm;

FIG. 6 contains a table of metrics for higher index spacer layer with various refractive index values, with high index layer thickness and gold rectangle size held constant and lower index layer held at a constant thickness of 10 nm and a refractive index of 1.5;

FIG. 7 contains a table of metrics for higher index spacer layer with various refractive index value, with absorption held constant at >99.9% by adjusting higher index layer thickness, with gold rectangle size held constant and lower index layer held at a constant thickness of 10 nm and a refractive index of 1.5;

FIG. 8 contains a table of metrics for lower index space layer thicknesses in the deep subwavelength regime with refractive index of 1.5;

FIG. 9A is a graph of radiative and nonradiative enhancement rates for an optimally located dipole emitter polarized in the out-of-plane direction; and

FIG. 9B is a graph of radiative and nonradiative enhancement rates for an optimally located dipole emitter polarized in the in-plane direction.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

There is a need in the art to increase light matter interaction strength in, and optical response of, thin film materials. Embodiments of the invention address this need and assist in increasing the efficiency and performance of detectors and nonlinear frequency converters as well as assist in increasing the repetition rate of optical emitters. Embodiments of the invention may be used in the areas of photodetectors, pyro-electric detectors, solar cells, nonlinear frequency convertors, and quantum based single photon emitters. Contemporary devices generally include a single spacer layer of plasmonic patch antennas, which have lower electro-magnetic field enhancement values as well as lower radiative enhancement rates and reduced quantum efficiency. The advantages of the embodiments of the invention include improvements in field enhancement, radiative enhancement, and quantum efficiency.

Embodiments of the invention encompass a metal-insulator-metal plasmonic patch antenna containing two (or more) thin film layers in the insulating region, which have different refractive index values. These embodiments provide improvements to contemporary plasmonic based metal-insulator-metal patch antennas, in some cases providing about seven times increase in electric field enhancement and a two order of magnitude increase in radiative enhancement rates versus as comparable single insulating layer devices.

By using a multilayer of dielectric materials in the spacer region in some embodiments, the confinement can be reduced down to single nm thicknesses. By hybridizing a contemporary plasmonic patch antennae design with the subwavelength guided plasmon mode design of a conductor-gap-dielectric system, extreme light confinement into films with thickness of λ/20,000 can occur at mid infrared wavelengths. At these dimensions, the gap plasmon mode is essentially confined to volumes on par with deep subwavelength nanofilms and 2D material monolayers/heterostructures. With strong out-of-plane field enhancement, as set out below, one can envision using such a hybrid structure for plasmonic enhancement and coupling of out-of-plane modes and emitters such hyperbolic phonon polariton modes in hexagonal boron nitride, epsilon near zero modes in deep subwavelength nanofilms, and dark and interlayer excitons in van der Walls structures.

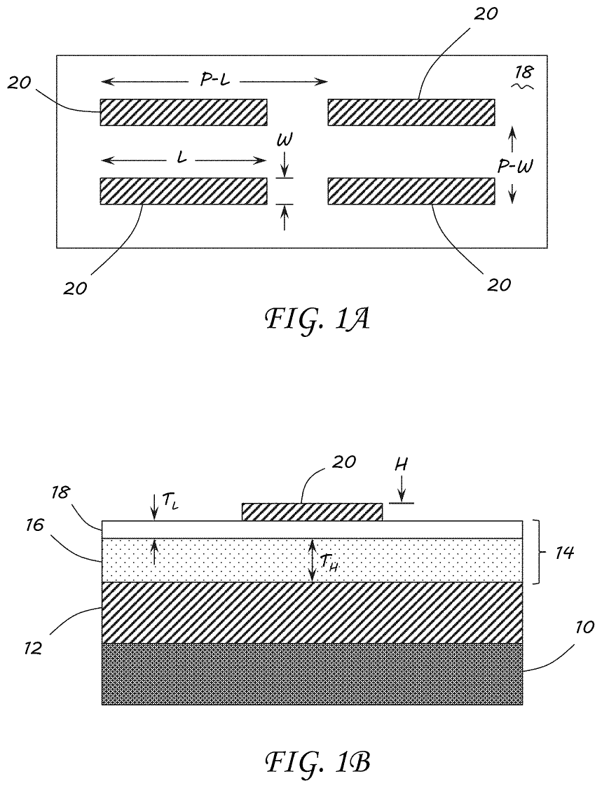

An exemplary embodiment of the invention is shown schematically in FIGS. 1A and 1B. It consists of an arbitrary substrate 10, an optically thick gold ground plane 12, a dielectric spacer multilayer 14, which first has a thick higher refractive index material 16 followed by a thin lower refractive index material 18, and finally a periodic array of gold rectangles 20. The gold rectangles have a constant height (H) of 100 nm, width (W) of 100 nm, and a variable length (L). The periodicity (P) in the width direction is 1000 nm and in the length direction it is 3000 nm. The refractive index of the two spacer layers is variable within a range between 1.5 and 4.0; these values could realistically correspond to BaF₂ and germanium. Various scenarios are analyzed and the degree of plasmonic field enhancement is determined by monitoring the maximum field strength of the gap plasmon mode. While the exemplary embodiment in FIGS. 1A and 1B use gold, other conductors may be used in other embodiments. Additionally, height, width and spacing of the rectangles may be of different sizes in other embodiments dependent on the application requirements for those embodiments.

Simulations were performed using a commercially available finite difference time domain software package from Lumerical Inc. of Vancouver, BC, Canada (www.lumerical.com). Symmetrical boundary conditions were used and mesh sizes were determined by performing convergence testing. A normally incident plane wave polarized along the length of the gold rectangles served as the excitation source.

Gold refractive index values were taken from E. D. Palick, Handbook of Optical Constants of Solids I (Academic, 1991) while user defined indices were set for the two spacer layers, with the imaginary part of the refractive index assumed to be zero.

Initially, parameters for a reference device, which contained only a single high index spacer layer material, were determined and this device then served as a point of reference for comparing subsequent multi-spacer layer results. With L=1220 nm, the high index material layer was set to a thickness of T_{H}=250 nm with index n_{H}=4.0 and the low index material layer as set to T_{L}=10 nm with index n_{L}=4.0. This is essentially the same as having one single 260 nm thick layer. Simulation results showed that this device has a >99.99% absorption resonance at 10,440 nm.

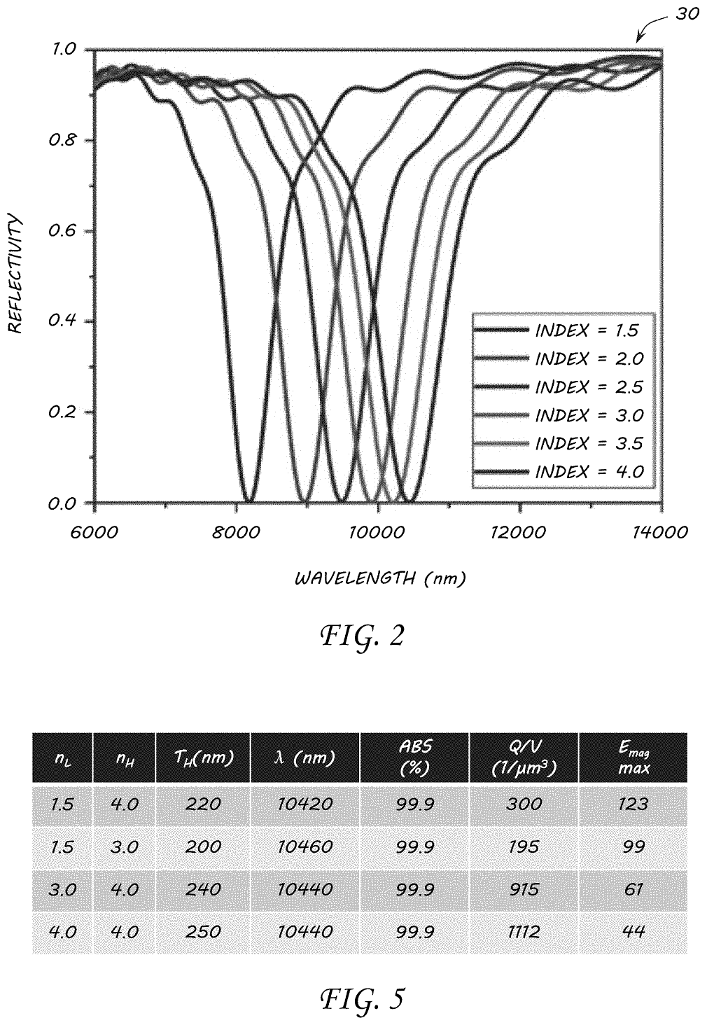

Next, the index of the low index layer was reduced down to 1.5 in steps of 0.5. For each index change T_{H} was adjusted in order to maintain perfect absorption. This resulted in a minimum T_{H} of 190 nm, which corresponds with the n_{L}=1.5 device. The reflectivity spectra for this set of devices is shown in the graph 30 in FIG. 2. For each device the plasmon resonance dip drops down to <10⁻². A redshift of the resonance occurs as n_{L} is reduced.

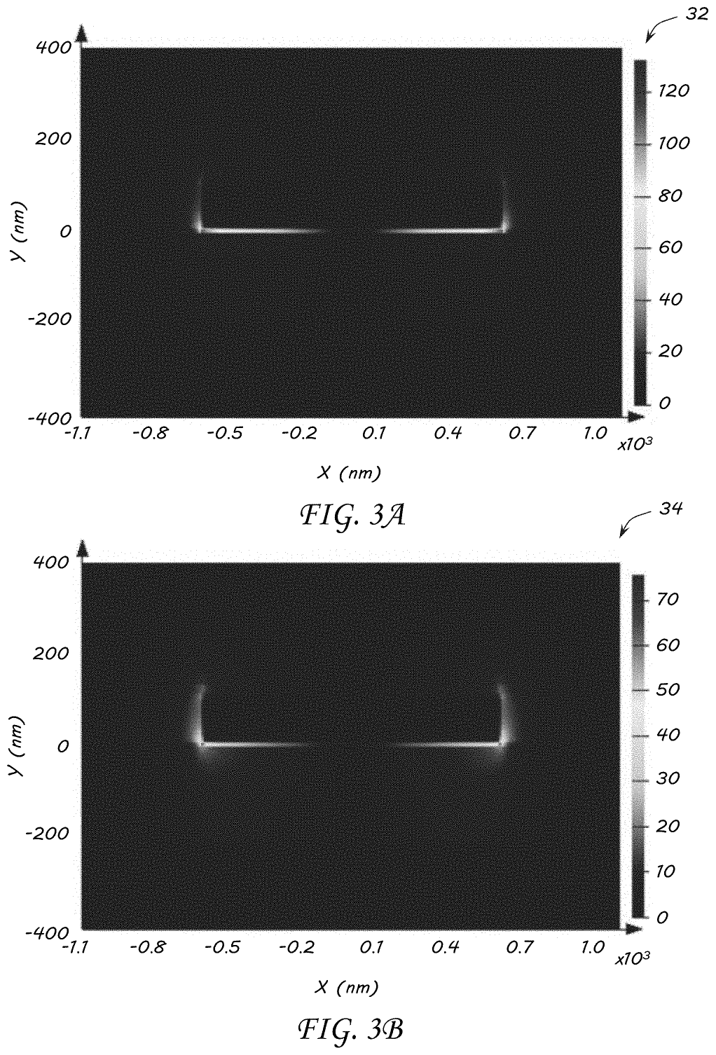

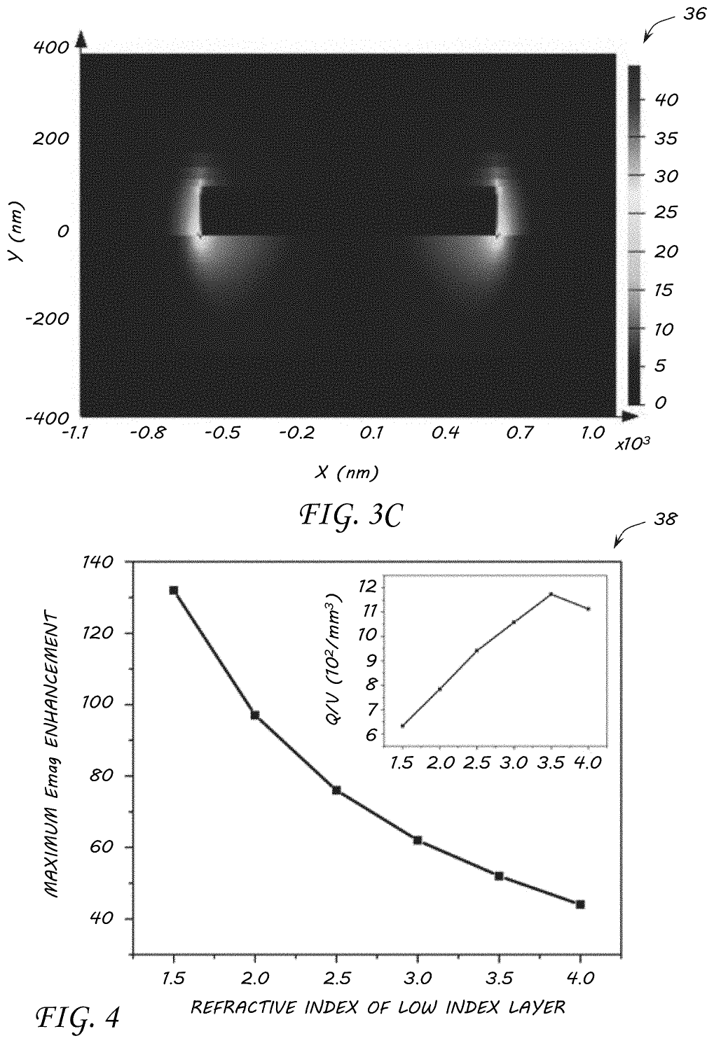

For each of these devices the electric field magnitude profile was determined. Three representative cases, with n_{L} equal to 1.5 (plot 32), 2.5 (plot 34), and 4.0 (plot 36) are shown n FIGS. 3A, 3B, and 3C respectively. For the n_{L}=4.0 case (effective single spacer layer) the electric field is seen to permeate more through the spacer region and also up along the edges of the gold rectangle (plot 36). As n_{L} is reduced the field concentrates into the lower index layer and slightly expands in the in-plane direction of that layer, directly underneath the gold rectangle. This results in an overall increase of the electric field magnitude.

As shown in graph 38 in FIG. 4, the maximum enhancement value goes up from 44 to 132 as n_{L} is reduced. In the inset of FIG. 4, the quality factor to mode volume, Q/V, is calculated. This ratio, which is directly proportional to the Purcell factor, is an often used metric for light matter interaction strength in cavity based systems. Q here is taken as ratio of the resonance wavelength to the full width at half max of the resonance and V is taken as the integrated volume of the electric field squared divided by the maximum value of the squared electric field. While there is not a lot of change in Q/V, it is larger for higher n_{L}. The reason for this is that the Q for all devices studied was relatively the same, within a range of 8 to 11, while V was actually larger for lower n_{L}. As set out above, at lower indices, the field is vertically squeezed; however, horizontally it somewhat spreads out within the low index layer, as specifically seen in the plot 32 in FIG. 3A.

Additionally, a study was completed where the resonant wavelength for each considered device was maintained at approximately 10,440 nm. This was accomplished by varying the gold rectangle length L and higher index spacer layer thickness T_{H} such that each device displayed perfect absorption at roughly the same wavelength. The set of devices studied in this case, along with their metrics, are summarized in the table in FIG. 5. As summarized in the table, as the contrast between the high index value and the low index value is increased the maximum field enhancement goes up. Conversely, the Q/V value generally decreases.

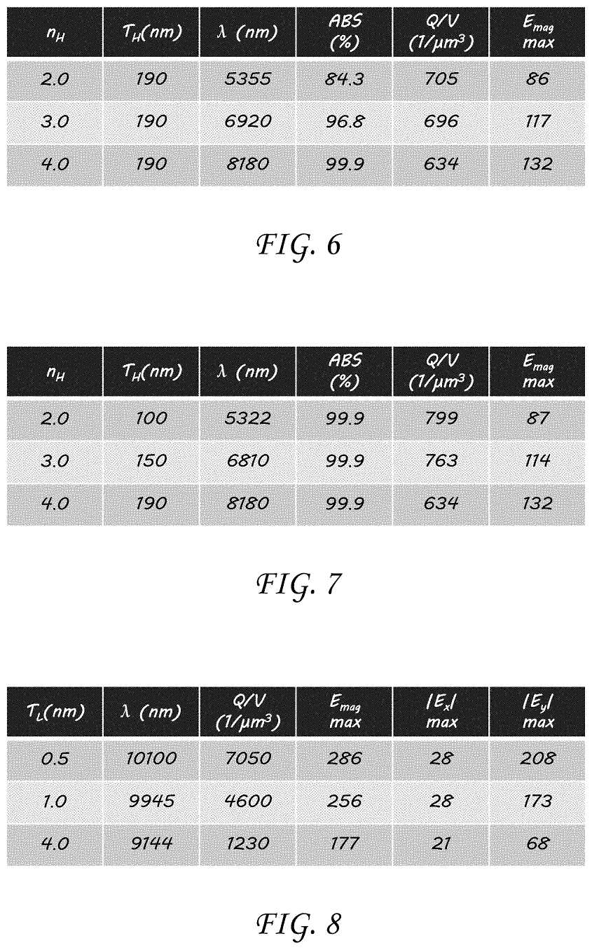

The third set of devices, summarized in the table in FIG. 6, compares the results when a constant lower index spacer layer of T_{L}=10 nm and n_{L}=1.5 is used and the index of the higher index spacer layer is varied between 2.0 to 4.0. Once again, larger index contrast leads to greater electric field enhancement with, in this case, only a slight decrease in Q/V. The devices summarized in the table in FIG. 7 are basically the same as from the table in FIG. 6, only now the thickness of the higher index layer is adjusted in order to maintain perfect light absorption. The values for Q/V and maximum field magnitude are very comparable indicating that absolute perfect light absorption is not necessarily required in order to achieve strong plasmonic enhancement.

The effect of further thinning down the lower index spacer layer, all the way down to values which could feasibly correspond to single monolayers of 2D materials, was also examined. Here the following were held constant: gold square length L=1220 nm, higher index spacer layer thickness T_{H}=210 nm with refractive index n_{H}=4.0, and lower index spacer layer refractive index nl=1.5. Three simulations were then performed with lower index spacer layer thickness of 4.0, 1.0, and 0.5 nm. The results are summarized in the table in FIG. 8. As expected, the maximum value of the electric field magnitude is further enhanced as the lower index spacer layer thickness T_{L} is reduced. Likewise, the Q/V also increases. At monolayer type dimensions of 0.5 nm the field enhancement is now 286 and Q/V=7050/μm³, which are the highest values for both metrics from any devices considered the tests presented.

For extremely thin lower index spacer layers, there is much more enhancement increase in the out-of-plane component E_{y} compared to the in-plane component Eₓ. As the dimensions are scaled down from 4.0 nm to 0.5 nm Eₓ increases by 1.3 times while E_{y} increases by 3.05 times. This very large enhancement of the out-of-plane electric field component implies that such devices should be able to provide very large plasmonic enhancement to thin films containing modes or emitters, which have out-of-plane dipole moments. For example, dark excitons in 2D materials, interlayer excitons in 2D heterostructures, epsilon near zero modes in thin films of <λ/50 thickness at their zero permittivity wavelengths, and out-of-plane phonon modes in materials such as hexagonal boron nitride. Furthermore, whereas traditionally such out-of-plane dipoles would require steep angle excitation in order to try to align the excitation source polarization with the dipole orientation, in the devices of the embodiments of the invention, normal incidence excitation is used.

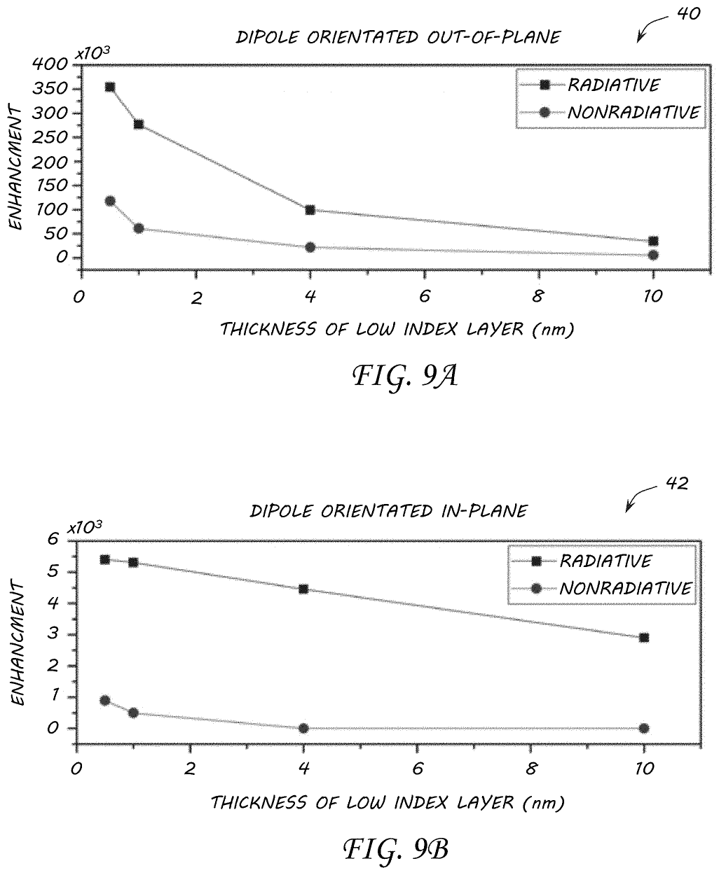

Finally, radiative and nonradiative enhancement rates were determined for the devices from the table in FIG. 8. An electric dipole was placed in the middle of the low index layer for the vertical position as well as the position along the width of the gold rectangle. In the length direction the dipole was positioned at the location of maximum field enhancement, which was at the very edge of the rectangle for out-of-plane polarization and 10 nm beyond the rectangle edge for in-plane polarization. The results, in the graphs 40, 42 in FIGS. 9A and 9B, show a linear increase in the enhancement rate for in-plane as the low index spacer layer thickness is reduced whereas out-of-plane has an exponential increase. For the thinnest layers there is almost two orders of magnitude more enhancement for out-of-plane oriented dipoles. At monolayer-like thicknesses of 0.5 nm, the out-of-plane rates are roughly 360,000 for radiative and 125,000 for nonradiative. These values indicate a quantum efficiency of about 75%.

Results from the exemplary embodiments above illustrate that by replacing the single spacer layer in a patch antennae with a multilayer composed of a thicker high index layer followed by a thinner low index layer, the electric field can become highly localized into the thinner low index layer. As the index contrast between the layers is increased the field enhancement also increases. In the extreme, a λ/20,000 thin film of 0.5 nm with an index of refraction of 1.5 sitting on a higher index layer provided a 286 times enhancement in the field magnitude with a majority of that enhancement, 208 times, in the out-of-plane direction. For an optimally located dipole a radiative enhancement of 360,000 was seen with 75% quantum efficiency.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. For example, while these studies on the exemplary embodiments were performed at mid infrared wavelengths with an eye towards coupling of vibrational states, ENZ modes, and phonon modes, the embodiments of the invention could easily be scaled down to near infrared. Thus, the invention in its broader aspects is therefore not limited to the specific details, representative apparatus and method, and illustrative examples shown and described. Accordingly, departures may be made from such details without departing from the scope of the general inventive concept.

What is claimed is:

1. A plasmonic patch antenna, comprising:
a substrate;
an optically thick ground plane proximate the substrate;
a first dielectric material with a first refractive index proximate the ground plane;
a second dielectric material with a second refractive index proximate the first dielectric material; and
a periodic array of conducting rectangles proximate the second dielectric material,
wherein the first refractive index is greater than the second refractive index, and
wherein a thickness of the first dielectric material is greater than a thickness of the second dielectric material.

2. The plasmonic patch antenna of claim 1, wherein a material of the periodic array of conducting rectangles comprises gold.

3. The plasmonic patch antenna of claim 1, wherein a material of the optically thick ground plane comprises gold.

4. The plasmonic patch antenna of claim 1, wherein the first refractive index is within a range between about 1.5 and about 4.0.
